(19) United States
(12) Patent Application Publication
(10) Pub. No.: US 2013/0072052 A1
(43) Pub. Date: Mar. 21, 2013

(54) CONTACTING DEVICE

(71) Applicant: Jens Andresen, Blomberg (DE)

(72) Inventor: Jens Andresen, Blomberg (DE)

(21) Appl. No.: 13/616,968

(22) Filed: Sep. 14, 2012

Related U.S. Application Data
(63) Continuation of application No. PCT/EP2011/054005, filed on Mar. 16, 2011.

(30) Foreign Application Priority Data
Mar. 16, 2010 (DE) 10 2010 011 614.9

(51) Int. Cl. H01R 4/24

(52) U.S. Cl. 439/411

(57) ABSTRACT

The disclosure relates to a contacting device, by means of which a single-core or multi-core cable can be repeatedly connected very quickly and conveniently to an electrical device and disconnected therefrom again. For this purpose, an insulation displacement contact (6) and a screw mechanism (3, 7), which is equally suited for pressing the leads (8) into and removing said leads from the insulation displacement contacts (6) and which also makes it possible to release the clamping connection that is under mechanical stress (9) without the application of a major force, are provided.

### CROSS-REFERENCE TO RELATED APPLICATIONS

This application is a continuation of International Application No. PCT/EP2011/054005, filed Mar. 16, 2011, which claims the benefit of German Application No. 10 2010 011 614.9 filed Mar. 16, 2010, the entire disclosures of which are hereby incorporated by reference.

### FIELD OF THE INVENTION

The disclosure relates to a contacting device for establishing an electrically conductive connection with a cable, comprising an insulation displacement connector for producing an electrical connection with a conductor of the cable, and an insertion mechanism, with which the conductor of the cable can be inserted into the insulation displacement connector.

The present disclosure therefore lies in the field of installation engineering. The use of contacting devices is expedient for industrial but also for residential applications in all cases in which electrical components are to be connected to cables in an electrically conductive manner.

### BACKGROUND OF THE INVENTION

The requirements for connecting electrical components to cables are satisfied in various ways through a variety of known solutions and with varying degrees of efficiency. In addition to electrical properties and the secure contacting of the connection, these requirements include the important property of rapid installation, but also, for the purpose of repair and maintenance, rapid and convenient uninstallation.

Known solutions that enable rapid installation, for example, include contacting devices based on insulation displacement connector mechanisms. In such cases, the insulation of the cable to be contacted is cut through by a cutting edge such that the cutting edge contacts the conductor of the cable to be contacted in an electrically conductive manner. Spring mechanisms, which then constantly press the cutting edge onto the cable, prevent a loss of contact, and thereby ensure a secure connection.

For the uninstallation of such an insulation displacement connector, it is advantageous for the contact force that is usually exerted by springs to be releasable. However, not all configurations permit a removal of this spring force. More particularly, in those embodiments in which the cable is pressed in single-element, spring-mounted scissor clamps, removal of the spring force is not possible or is possible only with substantial structural expenditure.

The uninstallation of insulation displacement connections in which the compressive forces of the springs cannot be removed is therefore possible only with a corresponding application of mechanical force, since in order to remove the cable from the insulation displacement connector under the constantly acting spring force, additional frictional forces must be overcome. If, as is the case with multicore cables, multiple insulation displacement connectors are to be disconnected simultaneously, the corresponding forces to be applied are totaled. With larger conductor cross-sections, the tensile forces required to uninstall a multicore insulation displacement connection can become so great that they cannot be exerted by a single person, for example, standing on a ladder and working above his head. For instance, under certain circumstances, the uninstallation of an overhead ceiling light fixture can be carried out only with difficulty and/or only with the assistance of costly tools and/or safety measures.

The present disclosure therefore addresses the problem of designing a cable contacting and disconnection device such that it offers the advantages of a simple insulation displacement connector, particularly the structurally simple form with insulation displacement connectors that cannot be released, but at the same time can be easily disconnected.

The problem is solved according to the present disclosure by the features of the independent claim. Advantageous embodiments of the disclosure are specified in the dependent claims.

### SUMMARY

According to one aspect, therefore, a contacting device for establishing an electrically conductive connection with a cable is disclosed, wherein the contacting device comprises an insulation displacement connector for producing an electrical connection with a conductor of the cable, and an insertion mechanism, with which the conductor of the cable can be inserted into the insulation displacement connector, characterized in that a disconnection mechanism is provided, with which the conductor inserted into the insulation displacement connector can be removed therefrom again.

In other words, therefore, the present disclosure proposes that the contacting device should comprise mechanisms both for establishing and for disconnecting the electrical connection on the basis of insulation displacement connectors, which support both the installation and the uninstallation of the connection.

This is relevant particularly when the force achieved by spring action, with which the cutting edge is pressed against the conductor, cannot be removed. This is the case, for example, when the cable is pressed in single-element, spring-mounted scissor-type clamps. In this case, in which the two cutting edges of the scissor represent mutual cutting and counterpressure surfaces, the cutting and counterpressure surface are in a single component, so that the cutting edge cannot be retracted from the pressure surface without additional structural means. The clamp, which is spread open by the inserted cable, represents a constantly stressed spring, wherein the force achieved by the spring action, with which the cutting edge is pressed against the conductor, cannot be removed.

Structural means for releasing this clamp are also conceivable, and may include a device which draws the two cutting edges apart, or a device which forces the two cutting edges away from one another, e.g., by insertion of a spreading element. However, structural means of this type are complex and associated with relatively high cost.

As an alternative to releasing the spring force, an uninstallation of the connection can also be carried out in the stressed state, however, when the conductor is removed from the insulation displacement connector, corresponding frictional resistance must be overcome.

Advantageously, therefore, a screw mechanism or threaded mechanism is proposed, with the help of which both the compressive forces necessary for pressing the conductors into the insulation displacement contacts and the tensile forces necessary for the removal thereof can be established.

In this connection, the disclosure is advantageously embodied such that the insertion mechanism and disconnection mechanism contain at least one shared component. This advantage is even more significant if the insertion mechanism and/or disconnection mechanism are embodied as a screw mechanism. Advantageously, a shared screw element, which can be embodied, for example, as a coupling ring, is configured as part of an insertion mechanism and part of a disconnection mechanism.

Advantageously, the insertion mechanism includes a guide element, which guides the conductor in such a way that, by moving the guide element in the direction of the insulation displacement connector, the conductor can be pressed in the insulation displacement connector and contacted, and by moving the guide element in the opposite direction, the conductor can be removed from the insulation displacement connector. By fastening the conductor by means of the guide element, compressive forces and tensile forces can be effectively transferred to the conductor, so that the conductor can be inserted into and/or removed from the insulation displacement connector against the spring pressure.

The movement of the guide element in relation to the insulation displacement connector or in relation to an insulation displacement element that contains multiple insulation displacement connectors is advantageously achieved by means of a screw mechanism, which enables contacting and/or disconnection even under difficult installation conditions, such as on a tall ladder and overhead, by converting torque to compressive force or tensile force.

Advantageously, a coupling ring is pressed onto the guide element for this purpose. In this manner, the present disclosure can be cost-efficiently implemented on the side of the cable to be connected by means of two elements, specifically, the guide element and the coupling ring. If the insulation displacement element is equipped with external threading on the side of the cable connection, then according to the embodiment example, in addition to the insulation displacement contacts themselves, only one element is necessary for implementing the core of the present disclosure.

A further advantageous embodiment of the present disclosure consists in encompassing the area of the insulation displacement connectors completely by a housing having external threading, so that, with a housing of sufficient length, protection against contact is offered. Moreover, in combination with the coupling ring, a closed space is created, which protects the connection against environmental influences. Advantageously, this space is sealed by a radial seal. It is further advantageously provided that a release of tensile force prevents an unintended release of the connection.

With the design based upon the coupling ring and radial seal, a mechanical stop is further defined, which facilitates proper installation by the installer.

The above-described design involving pressing the coupling ring onto the guide element further offers the advantage that this application is capable of transferring both tensile and compressive forces. Therefore, the insertion mechanism and release mechanism are realized in a simple construction, which transfers the forces for moving the guide element both in the direction of the insulation displacement connector and in the opposite direction.

Furthermore, the guide element is advantageously embodied such that the cable to be connected can be inserted axially through the element. This enables a substantially round shape for receiving the coupling ring, and enables the spatial separation that is necessary for a clean insulation in the area of the insulation displacement connectors by way of a radial distribution of the individual conductors. By spreading the conductors toward the outside, said conductors are aligned orthogonally for accommodation in the insulation displacement connector, and are fastened by the guide element.

This arrangement further offers the advantage that the insulation displacement connectors can be arranged close to the outer edge in a triangular, square or finally a circular shape, based on the number of conductors, so that at their center, a hollow space for the space-saving accommodation of the guide element is created.

### BRIEF DESCRIPTION OF THE DRAWINGS

In what follows, the disclosure will be specified in greater detail with reference to the attached set of drawings, within the context of preferred embodiments.

FIGS. 1a and 1b show a cable connection element with locking and unlocking mechanism according to a preferred embodiment of the disclosure in a sectional illustration and from a plan view.

FIG. 2 shows an insulation displacement element according to a preferred embodiment of the disclosure from a perspective, partially cut-away view.

FIGS. 3a and 3b show an insulation displacement contact with and without pressed-in conductor.

### DETAILED DESCRIPTION OF THE PREFERRED EMBODIMENTS

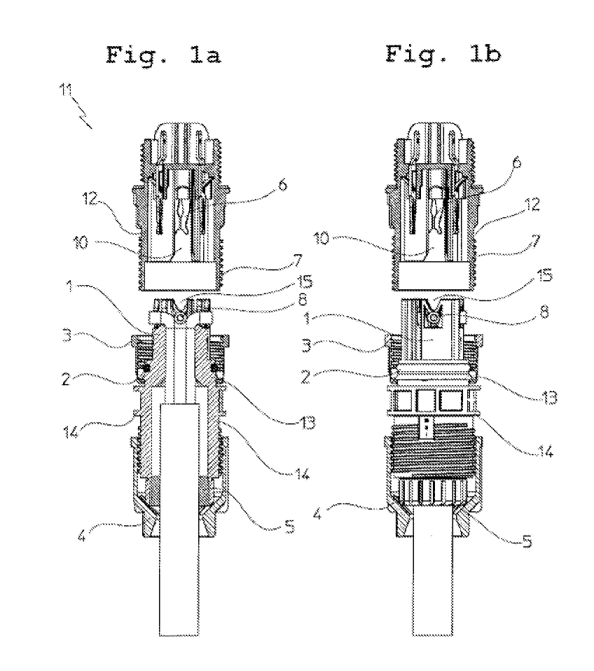

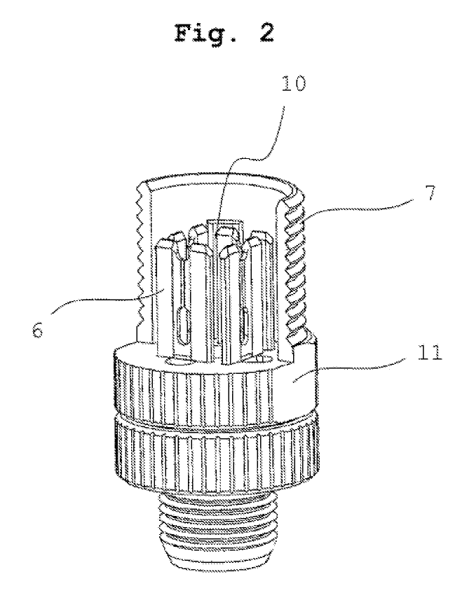

FIGS. 1a, 1b and 2 show a contacting device according to a preferred embodiment example of the disclosure, with a cable connecting element and a device connecting element. In this case, a guide element 1 is provided, through which the cable to be connected can be inserted from the side of the threaded cable connection 4, 5. On the other side of the guide element 1, also called a splicing element, the conductors 8 of the cable can be spread radially toward the outside, and can be fixed in the grooves 15 provided for this purpose.

The cable connection element further comprises a coupling ring 3, which is connected to the guide element 1 in such a way that it is rotatably mounted, but cannot be moved axially in either one or the other direction beyond a certain tolerance range. In the preferred embodiment example, the guide element 1 has an inner ring 13, over which the coupling ring 3 is pressed, so that it can be displaced axially between inner ring 13 and outer ring 14 only within the specific tolerance range. In this connection, the dimensions are preferably chosen such that the inner ring 13 prevents a removal of the coupling ring 4 up to the level of tensile forces that lie in the range of the cable removal forces. The cable connecting element further has a radial seal 2, which, when installed, enables a sealing of the interior space of the insulation displacement element 11.

FIG. 2 shows an embodiment example of the insulation displacement element 11 of the disclosure. The element has at least one U-shaped, double-sided insulation displacement connector 6, into which a conductor 8 can be pressed. The insulation displacement element 11 further comprises a hollow space 10 between the insulation displacement connectors 6, into which the guide element 1 of the cable connecting element can be inserted. By inserting the guide element 1 into the hollow space 10 of the insulation displacement element 11, the conductors 8 of the cable, which are spaced radially toward the outside, can be contacted by the insulation displacement connectors 6, cutting through the insulation of the conductors.

When the coupling ring 3 is screwed onto the external threading 7 of the insulation displacement element, the pressure necessary for pressing the conductors into the insulation displacement connectors 6 is applied, via the inner ring 13 of the guide element 1, to said insulation displacement element. Conversely, when the coupling ring 3 is loosened, pressure is built up against the outer ring 14 of the guide element 1, and as a result, the guide element 1 draws the conductors 8 of the cable out of the insulation displacement connectors 6, despite the frictional resistance.

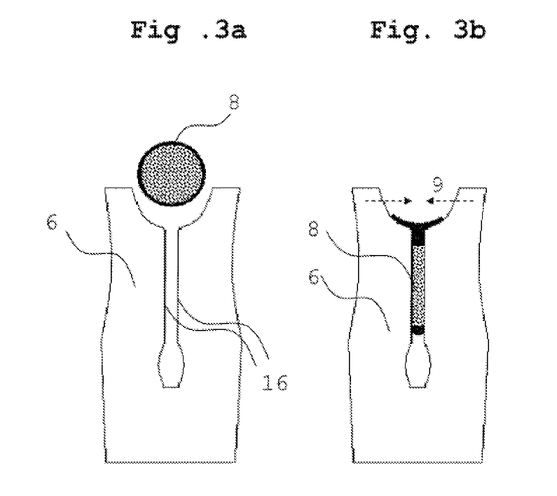

FIGS. 3a and 3b show an embodiment example of an insulation displacement connector 6, in which the spring force in the direction 9 cannot be released without additional structural means. FIG. 3a shows the conductor 8 in an unclamped state, and FIG. 3b shows said conductor in a clamped state.

In this case, in which the two cutting edges 16 represent mutual cutting and counterpressure surfaces, cutting and counterpressure surfaces are in a single component, so that the cutting edges cannot be retracted from the counterpressure surfaces without additional structural means. The clamp that is spread apart by the inserted cable represents a continuously stressed spring, wherein the force achieved by the spring action in the direction 9, with which the cutting edge is pressed against the conductors, cannot be removed.

### LIST OF REFERENCE SIGNS

Guide element (splicing element) 1
Radial seal 2
Coupling ring 3
Threaded cable connection, coupling ring 4
Threaded cable connection, rubber gasket 5
Insulation displacement connector 6
External threading of the insulation displacement element 7
Conductor 8
Direction of spring action 9
Hollow space between insulation displacement connectors 10
Insulation displacement element 11
Stop 12
Inner ring 13
Outer ring 14
Groove 15
Cutting element, cutting surface 16

1. A contacting device for establishing an electrically conductive connection with a cable, comprising:
an insulation displacement connector for producing an electrical connection with a conductor of the cable;
an insertion mechanism with which the conductor of the cable can be inserted into the insulation displacement connector; and
a disconnection mechanism with which the conductor inserted into the insulation displacement connector can be removed therefrom again.

2. The contacting device according to claim 1, characterized in that the spring force with which the insulation displacement connector presses against the inserted conductor cannot be released.

3. The contacting device according to claim 1, characterized in that the insertion mechanism and/or disconnection mechanisms embodied as a screw mechanism.

4. The contacting device according to claim 1, characterized in that the insertion mechanism has at least one component in common with the disconnection mechanism.

5. The contacting device according to claim 1, characterized in that the insertion mechanism comprises a guide element which guides the conductor in such a way that by moving the guide element in the direction of the insulation displacement connector, the conductor can be pressed into the insulation displacement connector and contacted, and by moving the guide element in the opposite direction, the conductor can be removed from the insulation displacement connector.

6. The contacting device according to claim 5, characterized in that the movement of the guide element in relation to the insulation displacement connector can be achieved by means of a screw mechanism.

7. The contacting device according to claim 5, characterized in that an insulation displacement element comprising at least one insulation displacement contact is provided, and the guide element or insulation displacement element has external threading or a coupling ring, so that by tightening or loosening the coupling ring on the external threading, the guide element can be moved in or opposite the direction of the insulation displacement connector.

8. The contacting device according to claim 7, characterized in that the at least one insulation displacement contact of the insulation displacement element is encompassed by a cylindrical housing with external threading, and the housing is sealed by means of a radial seal and the guide element.

9. The contacting device according to claim 7, characterized in that the coupling ring is pressed onto the guide element for the purpose of transferring both compressive force and/or tensile force.

10. The contacting device according to claim 1, characterized in that a threaded cable connection is provided, which serves as a tensile force release.
